(19) United States
(12) Patent Application Publication
(10) Pub. No.: US 2025/0075148 A1
(43) Pub. Date: Mar. 6, 2025

(54) PROCESSES FOR MAKING CONCENTRATED SURFACTANT BLENDS

(71) Applicant: The Procter & Gamble Company, Cincinnati, OH (US)

(72) Inventors: Christopher Stephen JONES, Strombeek-Bever (BE); Robby Renilde François KEULEERS, Lippelo (BE); Diederik Emiel Omer VANHOUTTE, Deinze (BE)

(21) Appl. No.: 18/825,076

(22) Filed: Sep. 5, 2024

(30) Foreign Application Priority Data
Sep. 6, 2023 (EP) 23195774.7
Apr. 24, 2024 (EP) 24172166.1

(51) Int. Cl. C11D 1/37; C11D 1/14; C11D 17/08

(52) U.S. Cl. CPC C11D 1/37; C11D 1/14; C11D 17/08; C11D 2111/10

(57) ABSTRACT

Processes for forming alkyl alkoxylated sulfate anionic surfactant containing concentrated surfactant blends having reduced levels of dioxane by-product while still providing good stability, grease cleaning and sudsing, include first forming an alkyl alkoxylated alcohol stream in which the alkyl alkoxylated alcohol stream includes at least two different alkyl alkoxylated alcohols, which differ in degree of alkoxylation by no more than 0.5, and then sulfating and neutralizing the alkyl alkoxylated alcohol stream to form the alkyl alkoxylated sulfate anionic surfactant.

### TECHNICAL FIELD

The present disclosure relates to processes for making concentrated surfactant blends, in particular, concentrated surfactant blends for use in making liquid detergent compositions, especially liquid hand dishwashing cleaning compositions.

### BACKGROUND

Liquid hand dishwashing detergent compositions are typically high sudsing and provide long-lasting suds, in addition to good grease removal, in order to provide a high level of consumer satisfaction. Generally, such detergent compositions comprise alkyl alkoxylated sulfate anionic surfactants as they provide both high, long-lasting suds during use, and good grease removal. The alkyl sulfated anionic surfactant is typically alkoxylated, especially ethoxylated, in order to improve low temperature stability for the resultant liquid detergent composition, while also providing the desired level of grease cleaning and sudsing performance.

Such alkyl alkoxylated sulfate anionic surfactants are typically made by processes involving an alkoxylation step where the alkyl alcohol is alkoxylated, followed by a sulfation step, and then a neutralisation step, since the alkyl alkoxylated sulfuric acids have poor hydrolytic stability. Once formed, the alkyl alkoxylated sulfate anionic surfactants are typically blended together, optionally with alkyl sulfated anionic surfactant which has not been alkoxylated, in order to arrive at the desired degree of alkoxylation. In addition, different alkyl alkoxylated sulfated anionic surfactant can be blended together to achieve the desired average alkyl chain length or degree of branching, or branching distribution.

When making alkoxylated, and especially ethoxylated alkyl sulfate surfactants, 1,4-dioxanes can be produced. Tight control of processing conditions and feedstock material compositions is typically needed, both during alkoxylation especially ethoxylation and sulfation steps, so that the amount of 1,4-dioxane by-product within alkoxylated especially ethoxylated alkyl sulfates can be minimised. Even if the 1,4-dioxane by-product level is kept to a minimum in the freshly formed surfactant blend, for many blends formed from prior art processes, the level of 1,4-dioxane by-product increases over time. The formation of 1,4-dioxanes has been found to be higher when concentrated alkyl ethoxylated sulfate blends are stored at higher pH.

As such, there remains a need for processes for forming alkyl alkoxylated sulfate anionic surfactant containing concentrated surfactant blends which have reduced levels of dioxane by-product.

U.S. Pat. Nos. 4,477,372A, 4,476,044A, and 4,476,045A relate to high active content surfactant wherein the anionic portion of the surfactant is neutralized with a secondary or tertiary amine containing at least three carbon atoms attached to the nitrogen atom of the amine, at least one alcoholic hydroxy group therein and such that the amine is alpha or beta substituted with respect to the nitrogen atom products. WO9418160A relates to a process for producing high active alkyl sulfate solutions comprising the steps of adding and mixing an alkyl sulfuric acid having a chain length of C12-C18, with an organic amine to produce a neutralized product having substantially no water. EP2964741A relates to a method of preparing a substantially anhydrous composition of alkyl (ethoxy) sulfate neutralized with an organic amine base, the said composition being suitable for use as a surfactant in an ecodose. WO201472840A relates to a process for preparing high-concentration, flowable aqueous fatty alkyl sulfate solution, said process comprises (i) ethoxylation of fatty alcohol with very low of about 0.3 to about 0.8 moles of ethylene oxide, and (ii) sulfating the ethoxylated fatty alcohol with specific reaction conditions, and (iii) neutralizing the sulfation product with an aqueous base, the obtained fatty alkyl sulfate solution contains at least 65% by weight of mixture of fatty alkyl sulfates and fatty alkyl ether sulfates in a weight ratio in the range from about 80:20 to about 50:50 wherein the average number of moles of ethylene oxide (EO) of the mixture is between 0.3 to 0.8; less than 3 ppm of dioxane; and water, and wherein the solution does not contain any antimicrobial or preservatives and is homogeneous, flowable and pumpable at 25° C. WO9738972A relates to sulfation methods for producing longer chain length alkyl sulfate and/or alkyl alkoxylated sulfate surfactant compositions, the method utilising the presence of a significant amount of mid-chain branched alcohol and/or polyoxyalkylene alcohol in the sulfation reaction to significantly reduce the reaction temperature, thereby improving product quality and saving energy. WO9404640A relates to a concentrated aqueous surfactant solution comprising alkyl ether sulfate and alkaline earth metal, preferably magnesium, the composition is a stable liquid which is suitable for making into cleaning products, especially dish washing liquids, the concentrated surfactant solution can be prepared by partial neutralisation of the acid precursor with the hydroxide or oxide of the alkaline earth metal, followed by a further neutralisation with the hydroxide of an alkali metal or ammonium. WO9105764A relates to the sulfatisation of ethoxylised alkanols obtained by the reaction of ethylene oxide with alcohols with 8 to 22 C atoms in the presence of a hydrotalcite catalyst provides alkyl polyethoxy ether sulfates distinguished by a low dioxane content and extremely good coagulability using ordinary electrolytes. US20170158625A relates to a process for preparing an alcohol ether sulfate which comprises: (a) sulfating an alkoxylated alcohol; and (b) neutralizing the sulfated product of step (a) in the presence of a base and a co-solvent having a flash point of at least 60° C. GB977281A relates to surface active sulfates of alkyl ether alcohols, wherein the ether-alcohol may be made by (a) the reaction of olefins with ethylene glycol, (b) the reaction of olefins with ethylene halohydrins, followed by hydrolysis of the halogen-containing products, or (c) the reaction of secondary or tertiary alcohols with ethylene oxide, and wherein the products are all sulfated with chlorosulfonic acid. EP3919594A1 relates to a liquid detergent composition suitable for washing dishes, fitting both in-sink as well as direct application habits, which provides reduced smearing when used in direct application dishwashing methods, while having good suds mileage especially under in-sink application habit, and good viscosity, the liquid detergent composition comprising a surfactant system, which comprises an alkyl sulfate anionic surfactant comprising C13 alkyl sulfate anionic surfactant, the C13 alkyl sulfate anionic surfactant comprising a specific fraction of 2-branched C13 alkyl sulfate anionic surfactant, with a specific distribution of the 2-branching. EP4249578A a process whereby a buffering surfactant is added before or during the neutralisation step of the alkyl sulfuric acid stream to form the alkyl sulfate anionic surfactant. WO2014034681A relates to a method for producing a polyoxyethylene alkyl ether sulfate, which comprises: a sulfation step wherein an ethylene oxide addition product of an alkyl alcohol having 8-22 carbon atoms is reacted with an SO3-containing gas, thereby obtaining a sulfated product of the ethylene oxide addition product; and a neutralization step wherein the sulfated product is neutralized, thereby obtaining a sulfate. US2021395643A relates to a liquid detergent composition suitable for washing dishes, fitting both in-sink as well as direct application habits, which provides reduced smearing when used in direct application dishwashing methods, the liquid detergent composition comprises a surfactant system, which comprises an alkyl sulfate anionic surfactant comprising C13 alkyl sulfate anionic surfactant, the C13 alkyl sulfate anionic surfactant comprising a specific fraction of 2-branched C13 alkyl sulfate anionic surfactant, with a specific distribution of the 2-branching. WO2014072840A relates to a process for preparing high-concentration, flowable aqueous fatty alkyl sulfate solution, said process comprising (i) ethoxylation of fatty alcohol with very low of about 0.3 to about 0.8 moles of ethylene oxide, and (ii) sulfating the ethoxylated fatty alcohol with specific reaction conditions, and (iii) neutralizing the sulfation product with an aqueous base. WO2023172859A relates to a process for making a concentrated surfactant blend which does not require a high pH in order to be hydrolytically stable, and as such, can be used to form detergent compositions which do not comprise high levels of salts or require the addition of high levels of organic solvents or structurants in order to be stable, and have the desired viscosity, dissolution and foaming profile.

### SUMMARY

The present disclosure relates to a process for making a concentrated surfactant blend, wherein the concentrated surfactant blend comprises a blend of alkyl alkoxylated sulfate anionic surfactants, wherein the process comprises the following steps: a blending step wherein: at least two different alkoxylate alcohols having a mol average degree of alkoxylation of 2.0 or less are blended together, to provide an alkyl alkoxylated alcohol stream, wherein: the at least two different alkoxylated alcohols have a mol average degree of alkoxylation which differs by no more than 0.5; and the starting alkyl alcohols used to produce the at least two different alkyl alkoxylated alcohols differ in chain length distribution, average degree of branching, branching distribution, or a combination thereof; or at least two alkyl alcohols are blended together to provide an alkyl alcohol stream, wherein the at least two alkyl alcohols differ in chain length distribution, average degree of branching, branching distribution, or a combination thereof; and the alkyl alcohol stream is alkoxylated to a mol average degree of alkoxylation of 2.0 or less, to provide an alkyl alkoxylated alcohol stream; a sulfation step, during which the alkyl alkoxylated alcohol stream is sulfated to provide an alkyl alkoxylated sulfuric acid stream; a neutralisation step, during which the alkyl alkoxylated sulfuric acid stream is neutralised, wherein: the resultant concentrated surfactant blend has a pH of at least 7.0 when measured as a 10% by weight solution of the concentrated surfactant blend in demineralized water at 20° C.

### DETAILED DESCRIPTION

Alkyl alkoxylated sulfate anionic surfactants having different chain lengths or type and degree of branching have been blended together in order to achieve the desired performance, such as the low temperature stability of the resultant detergent composition, its sudsing performance, or its efficacy against greasy soils. It has been found that the processes described herein result in a concentrated surfactant blend comprising alkyl alkoxylated sulfate anionic surfactants, in which the level of 1,4-dioxane by-product is reduced. In addition to providing reduced levels of 1,4-dioxane, the surfactant blend, and liquid compositions comprising them, have improved low temperature stability, while also providing the desired level of grease cleaning and sudsing performance.

As used herein, articles such as “a” and “an” when used in a claim, are understood to mean one or more of what is claimed or described.

The term “comprising” as used herein means that steps and ingredients other than those specifically mentioned can be added. This term encompasses the terms “consisting of” and “consisting essentially of.” The compositions of the present disclosure can comprise, consist of, and consist essentially of the essential elements and limitations of the examples described herein, as well as any of the additional or optional ingredients, components, steps, or limitations described herein.

The term “dishware” as used herein includes cookware and tableware made from, by non-limiting examples, ceramic, china, metal, glass, plastic (e.g., polyethylene, polypropylene, polystyrene, etc.) and wood.

The term “grease” or “greasy” as used herein means materials comprising at least in part (i.e., at least 0.5 wt % by weight of the grease in the material) saturated and unsaturated fats and oils, preferably oils and fats derived from animal sources such as beef, pig and/or chicken.

The terms “include”, “includes” and “including” are meant to be non-limiting.

The term “particulate soils” as used herein means inorganic and especially organic, solid soil particles, especially food particles, such as for non-limiting examples: finely divided elemental carbon, baked grease particle, and meat particles.

The term “sudsing profile” as used herein refers to the properties of a cleaning composition relating to suds character during the dishwashing process. The term “sudsing profile” of a cleaning composition includes initial suds volume generated upon dissolving and agitation, typically manual agitation, of the cleaning composition in the aqueous washing solution, and the retention of the suds during the dishwashing process. Preferably, hand dishwashing cleaning compositions characterized as having “good sudsing profile” tend to have high initial suds volume and/or sustained suds volume, particularly during a substantial portion of or for the entire manual dishwashing process. This is important as the consumer uses high suds as an indicator that enough cleaning composition has been dosed. Moreover, the consumer also uses the sustained suds volume as an indicator that enough active cleaning ingredients (e.g., surfactants) are present, even towards the end of the dishwashing process. The consumer usually renews the washing solution when the sudsing subsides. Thus, a low sudsing cleaning composition will tend to be replaced by the consumer more frequently than is necessary because of the low sudsing level.

It is understood that the test methods that are disclosed in the Test Methods Section of the present application must be used to determine the respective values of the parameters of Applicants' examples as described and claimed herein.

All percentages are by weight of the total composition, as evident by the context, unless specifically stated otherwise. All ratios are weight ratios, unless specifically stated otherwise, and all measurements are made at 25° C., unless otherwise designated.

### Process for Making a Concentrated Surfactant Blend:

The present process is used to make a concentrated surfactant blend. The concentrated surfactant blend comprises alkyl alkoxylated sulfate anionic surfactant. The anionic surfactant in the concentrated surfactant blend can comprise further anionic surfactant. However, the concentrated surfactant blend preferably consists of the blend of alkyl alkoxylated sulfate anionic surfactant, and optionally non-alkoxylated alkyl sulfate anionic surfactant. The process comprises at least the following steps: a blending step; a sulfation step; and a neutralisation step.

### Blending Step:

Alkyl alcohols typically comprise a distribution of alkyl chain lengths and/or branching. This is because they are typically made from natural sources such as palm oil or coconut all, or are synthesised from crude oil derivatives, or are derived from other synthetic processes such as the Fischer-Tropsch process. Virtually all such sources result in an alkyl alcohol having a distribution of alkyl chain lengths. While naturally derived fatty alcohols are typically fully linear, chemical processes for making alkyl alcohols from non-naturally derived materials typically result in a distribution of branching. The distribution of chain lengths can be reduced, for instance through refining. In addition, the branching distribution can be adjusted, based on the choice of feedstock and process settings. Such distribution of chain lengths and branching directly arising from such natural or synthetic sources is not regarded as the result of a blending step of use in processes of the present disclosure. Indeed, such alkyl alcohols are to be blended together in order to provide the desired properties for the subsequent detergent composition.

In the blending step of the present disclosure, an alkyl alkoxylated alcohol stream is formed which comprises at least two different alkyl alkoxylated alcohols, which differ in degree of alkoxylation by no more than 0.5. To form the alkyl alkoxylated alcohol stream, either at least two different alkoxylated alcohols having a mol average degree of alkoxylation of 2.0 or less, preferably from 0.1 to 2.0, more preferably from 0.2 to 1.5, most preferably from 0.4 to 0.9, are blended together, to provide an alkyl alkoxylated alcohol stream, or at least two different alkyl alcohols are blended together to provide an alkyl alcohol stream which is then alkoxylated to provide the alkoxylated alcohol stream having the desired mol average degree of alkoxylation. In the first case, the at least two different alkoxylated alcohols have a mol average degree of alkoxylation which differs by no more than 0.5, preferably by no more than 0.25, more preferably no more than 0.15.

Hence, the alkyl alcohol can be a blend of alkyl alcohols which are first blended together and then jointly alkoxylated to provide the desired average degree of alkoxylation. Alternatively, one or more of alcohols can first be alkoxylated, and then the alkoxylated alcohols or alcohol blends can be mixed together to achieve the desired average degree of alkoxylation. In the first case, a monomodal distribution of the alkoxylation is directly achieved, while in the second case, a broad distribution of alkoxylation is minimized by controlling the difference in average degree of alkoxylation between the starting alkoxylated alcohol materials. It has been found that a too broad or multimodal distribution of alkoxylation, and especially ethoxylation, can give rise to a higher level of 1,4-dioxane biproduct, especially when the alkyl alcohols are alkoxylated to a high average degree.

When at least two different alkoxylated alcohols are blended together to provide the alkyl alkoxylated alcohol stream, the at least two different alkoxylated alcohols have a mol average degree of alkoxylation which differs by no more than 0.5, preferably by no more than 0.25, preferably by no more than 0.15. The starting alkyl alcohols used to produce the at least two different alkyl alkoxylated alcohols differ in mol average chain length distribution, average degree of branching or branching distribution, or a combination thereof. As such, the starting alcohols that are blended together are selected in order to provide the desired properties of the alkyl alkoxylated sulfated anionic surfactant in the concentrated surfactant blend. In particular, the selection of mol average alkyl chain length and/or average degree and type and/or distribution of branching influences the balance between low temperature stability, grease cleaning and sudsing benefits provided by the resultant blend.

Alternatively, at least two alkyl alcohols are blended together to provide an alkyl alcohol stream, wherein the at least two alkyl alcohols differ in weight average chain length distribution, average degree of branching, type of branching and branching distribution, or a combination thereof; and the alkyl alcohol stream is subsequently alkoxylated to the desired mol average degree of alkoxylation, to provide the alkyl alkoxylated alcohol stream.

Alkoxylation, such as ethoxylation, propoxylation and butoxylation, is a chemical reaction in which ethylene oxide, propylene oxide, and butylene oxide, respectively is added to an alkyl alcohol. Such processes are well known in the art. The reaction typically proceeds by blowing the oxide, such as ethylene oxide, through the alkyl alcohol at around 180° C. and under a pressure of around 1-2 bar of pressure, with a catalyst such as potassium hydroxide (KOH). The process is highly exothermic and hence requires careful control to avoid a potentially thermal runaway. Improved control of the process and a narrower alkoxylation distribution can be achieved by the use of more sophisticated catalysts. Such catalysts are typically proprietary.

Where ethoxylation and propoxylation is desired, both reactions can be performed in the same reactor and may be run simultaneously to give a random distribution, or in alternation to obtain block distribution of the alkoxylations.

The alkyl alkoxylated alcohol in the alkyl alkoxylated alcohol stream can have alkyl chains having a mol average alkyl chain length of from 8 to 18, preferably from 10 to 14, most preferably from 12 to 13 carbon atoms, in order to provide a combination of improved sudsing and grease removal and enhanced speed of cleaning from the resultant alkyl sulfate surfactant.

The alkyl alkoxylated alcohol in the alkyl alkoxylated alcohol stream can have a weight average degree of branching of from 15% to 50%, preferably from 20% to 45%, more preferably from 25% to 40%. The alkyl alcohol used to make the alkyl alkoxylated alcohol can comprise C2-branched alkyl alcohol and non-C2-branched alkyl alcohol, wherein: the weight ratio of non-C2-branched alkyl alcohol to C2-branched alkyl alcohol is greater than 0.5, preferably from 1.0:1 to 5:1, more preferably from 2:1 to 4:1; and the non-C2 branched alkyl alcohol comprises less than 30%, preferably less than 20%, more preferably less than 10% by weight of the non-C2 branched alkyl alcohol of C1-branched alkyl alcohol, most preferably the non-C2 branched alkyl alcohol is free of C1-branched alkyl alcohol.

Alternatively, the alkyl alkoxylated alcohol in the alkyl alkoxylated alcohol stream can have a weight average degree of branching of less than 15%, or even linear, such as through the use of naturally derived alkyl chains. For instance, through the use of at least two different alkoxylated alcohols wherein at least one, preferably two, more preferably all the alkyl chains are linear, in which the mol average degree of alkoxylation of the alkoxylated alcohols differ by no more than 0.5.

The alkoxylation of the alkyl alkoxylated alcohol in the alkyl alkoxylated alcohol stream is preferably selected from ethoxylation, propoxylation, and a mixture thereof, preferably the alkoxylation consists of ethoxylation.

The alkyl alcohol is typically not fully alkoxylated. Indeed, when the average degree of alkoxylation of the alkyl alkoxylated alcohol in the alkyl alkoxylated alcohol stream is low, the alkyl alkoxylated alcohol stream can comprise a significant portion of alkyl alcohol which has not been alkoxylated. When the average degree of alkoxylation of the alkyl alkoxylated alcohol is less than 1.0, the alkyl alkoxylated alcohol stream always comprises alkyl alcohol which has not been alkoxylated. As such, the alkyl alkoxylated alcohol stream can comprise up to 90%, preferably up to 85%, more preferably up to 80% by weight of alkyl alcohol which has not been alkoxylated. The alkyl alkoxylated alcohol stream can comprise at least 25%, preferably at least 40% of alkyl alcohol which has not been alkoxylated. Therefore, the resultant concentrated surfactant bend will typically also contain some alkyl sulfate anionic surfactant which does not comprise alkoxylation.

The alkyl chains of the blend of alkyl alcohols used to make the alkyl alkoxylated alcohols in the alkyl alkoxylated alcohol stream can have a mol fraction of C12 and C13 chains of at least 50%, preferably at least 65%, more preferably at least 80%, most preferably at least 90%. Suds mileage is particularly improved, especially in the presence of greasy soils, when the C13/C12 mol ratio of the alkyl chain in the alkyl alcohol or in the blend of alkyl alcohols used to make the alkyl sulfate surfactant is at least 57/43, preferably from 60/40 to 90/10, more preferably from 60/40 to 80/20, most preferably from 60/40 to 70/30, while not compromising suds mileage in the presence of particulate soils.

The relative molar amounts of C13 and C12 alkyl chains in the alkyl alcohol or in the blend of alkyl alcohols can be derived from the carbon chain length distribution in the alkyl chain of the alkyl alcohol. The carbon chain length distribution of the alkyl chains of the alkyl alcohols can be obtained from the technical data sheets from the suppliers for the constituent alkyl alcohol. Alternatively, the chain length distribution and average molecular weight of the alkyl alcohols, used to make the alkyl alkoxylated sulfate anionic surfactant, can also be determined by methods known in the art. Such methods include capillary gas chromatography with flame ionisation detection on medium polar capillary column, using hexane as the solvent.

The average degree of alkoxylation is the mol average degree of alkoxylation (i.e., mol average alkoxylation degree) of all the alkyl alcohol. Hence, when calculating the mol average alkoxylation degree, the mols of non-alkoxylated alkyl alcohols are included:

Mol average alkoxylation degree=(x1*alkoxylation degree of alkyl alcohol 1+x2*alkoxylation degree of alkyl alcohol 2+ . . . )/(x1+x2+ . . . )
wherein x1, x2, . . . are the number of moles of each alkyl (or alkoxy) alcohol of the mixture and alkoxylation degree is the number of alkoxy groups in each alkyl alcohol.

Preferred alkyl alkoxy alcohols for use in making the alkyl sulfate surfactant are alkyl ethoxy alcohols

The performance can be affected by the width of the alkoxylation distribution of the resultant alkoxylated alkyl sulfate anionic surfactant, including grease cleaning, sudsing, low temperature stability and viscosity of the finished product. The alkoxylation distribution, including its broadness can be varied through the selection of catalyst and process conditions when making the alkoxylated alkyl alcohol.

If alkoxylation, such as ethoxylation, of the alkyl alcohol is desired, without wishing to be bound by theory, through tight control of processing conditions and feedstock material compositions, both during alkoxylation especially ethoxylation and sulfation steps, the amount of 1,4-dioxane by-product within alkoxylated especially ethoxylated alkyl sulfates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. Processes to control 1,4-dioxane content within alkoxylated/ethoxylated alkyl sulfates have been described extensively in the art. Alternatively 1,4-dioxane level control within detergent formulations has also been described in the art through addition of 1,4-dioxane inhibitors to 1,4-dioxane comprising formulations, such as 5,6-dihydro-3-(4-morpholinyl)-1-[4-(2-oxo-1-piperidinyl)-phenyl]-2-(1-H)-pyridone, 3-α-hydroxy-7-oxo stereoisomer-mixtures of cholinic acid, 3-(N-methyl amino)-L-alanine, and mixtures thereof.

The alkyl alcohol has a weight average degree of branching of from 15% to 50%, preferably from 20% to 45%, more preferably from 25% to 40%. The use of such branched alkyl alcohols can result in improved low temperature stability for compositions comprising the resultant alkyl sulfate surfactant, as well as providing the desired grease cleaning performance.

Through tight control of the C2-branching of the alkyl alcohols, the resultant alkyl sulfate surfactants have been found to provide liquid detergent compositions with improved product stability, even at low temperatures, and provide higher finished product viscosities, without compromising on suds mileage and grease cleaning.

Moreover, such compositions require less solvent in order to achieve good physical stability at low temperatures. Higher surfactant branching also provides faster initial suds generation, but typically less suds mileage. The weight average branching, described herein, has been found to improve low temperature stability, initial foam generation and suds longevity in liquid detergent compositions comprising alkyl sulfate surfactants formed from such alkyl alcohols.

As such, the branched alkyl alcohol used to make the alkyl sulfate surfactant can comprise C2-branched alkyl alcohol and non-C2-branched alkyl alcohol. The weight ratio of non-C2-branched alkyl alcohol to C2-branched alkyl alcohol can be greater than 0.5, preferably from 1.0:1 to 5:1, more preferably from 2:1 to 4:1.

C2-branched means the alkyl branching is a single alkyl branching on the alkyl chain of the alkyl alcohol and is positioned on the C2 position, as measured counting carbon atoms from the hydroxyl group for non-alkoxylated alkyl alcohol, or counting from the alkoxy-group furthest from the hydroxyl group for alkoxylated alkyl alcohols.

Non-C2 branching means the alkyl chain comprises branching at multiple carbon positions along the alkyl chain backbone, or a single branching group present on a branching position on the alkyl chain other than the C2 position.

The non-C2 branched alkyl alcohol can comprise less than 30%, preferably less than 20%, more preferably less than 10% by weight of the non-C2 branched alkyl alcohol of C1-branched alkyl alcohol, most preferably the non-C2 branched alkyl alcohol is free of C1-branched alkyl alcohol.

The non-C2 branched alkyl alcohol can comprise at least 50%, preferably from 60 to 90%, more preferably from 70 to 80% by weight of the non-C2 branched alkyl alcohol of isomers comprising a single branching at a branching position greater than the 2-position. That is, more than 2 carbons atoms away from the hydrophilic headgroup, as defined above. The non-C2 branched alkyl alcohol can comprise from 5% to 30%, preferably from 7% to 20%, more preferably from 10% to 15% by weight of the non-C2 branched alkyl alcohol of multi branched isomers. The non-C2 branched alkyl alcohol can comprise from 5% to 30%, preferably from 7% to 20%, more preferably from 10% to 15% by weight of non-C2 branched alkyl alcohol of cyclic isomers. If present, the acyclic branching groups can be selected from C1 to C5 alkyl groups, and mixtures thereof.

The weight average degree of branching for an alkyl alcohol mixture can be calculated using the following formula:

Weight average degree of branching (%)=[(x1*wt % branched alkyl alcohol 1 in alcohol 1+x2*wt % branched alkyl alcohol 2 in alcohol 2+ . . . )/(x1+x2+ . . . )]*100
wherein x1, x2, . . . are the weight in grams of each alkyl alcohol in the total alkyl alcohol mixture of the alkyl alcohols which were used as starting material before (alkoxylation and) sulfation to produce the alkyl (alkoxy) sulfate surfactant. In the weight average degree of branching calculation, the weight of the alkyl alcohol which is not branched is included.

The weight average degree of branching and the distribution of branching can typically be obtained from the technical data sheet for the surfactant or constituent alkyl alcohol. Alternatively, the branching can also be determined through analytical methods known in the art, including capillary gas chromatography with flame ionisation detection on medium polar capillary column, using hexane as the solvent. The weight average degree of branching and the distribution of branching is based on the starting alkyl alcohol used to produce the alkyl alkoxylated sulfate anionic surfactant.

Suitable examples of commercially available alkyl alcohols include, those derived from alcohols sold under the Neodol® brand-name by Shell, or the Lial®, Isalchem®, and Safol® brand-names by Sasol, or some of the natural alcohols produced by The Procter & Gamble Chemicals company. The alcohols (and alkoxylated alcohols) can be blended in order to achieve the desired mol fraction of C12 and C13 chains and the desired C13/C12 ratio, based on the relative fractions of C13 and C12 within the starting alcohols (as well as the desired degree of alkoxylation), as obtained from the technical data sheets from the suppliers or from analysis using methods known in the art.

The alkyl alcohol can comprise alkyl chains which are essentially linear or even fully linear, which are blended with the branched alcohol to achieve the desired degree of branching. Preferred sources of naturally derived alkyl chains include palm kernel and coconut derived alkyl chains, with palm kernel derived alkyl chains being more preferred. The naturally derived alkyl chain can be fractionated in order to provide the desired average alkyl chain length, as well as to adjust the alkyl chain length distribution. The C12 to C14 fraction is often referred to as the mid cut fraction within the naturally derived alkyl chains. Alternatively, essentially linear alkyl chains can be synthetically derived using the Ziegler process, or a derivative thereof, a method for producing fatty alcohols from ethylene using an organoaluminium compound. The reaction produces linear primary alcohols with an even numbered carbon chain. Again, the C12-C14 alkyl fraction is preferred and can be fractionated out of the total Ziegler alcohol.

### Sulfation Step:

In the sulfation step, the alkyl alkoxylated alcohol stream comprising the blend of alkyl alkoxylated alcohols is sulfated to form an alkyl sulfuric acid stream. The alkyl alkoxylated sulfuric acid stream comprises a blend of alkyl alkoxylated sulfuric acids having a mol average degree of alkoxylation of 2.0 or less, comprising at least two alkyl alkoxylated sulfuric acids having alkyl chains which differ in chain length distribution, average degree of branching or branching distribution, or a combination thereof.

Sulfation involves forming a carbon-oxygen-sulfur bond. The resultant alkyl sulfates in acid form (alkyl sulfuric acid) are not hydrolytically stable. Unless neutralized, it decomposes to form sulfuric acid and other chemicals.

Sulfation of alcohols or alkoxylated alcohols into (alkoxylated) alkyl sulfuric acids has been described extensively. More details of such a sulfation step has been described in “Sulf(on)ation Technology in the Detergent Industry” (W. Herman de Groot, Springer-Science+Business Media, B. V., 1991, ISBN 978-90-481-4088-6).

Various reagents can be used for the sulfation step, with sulfur trioxide (SO₃) being particularly preferred, at least partially due to its low cost. SO₃ is an aggressive electrophilic reagent that rapidly reacts with any organic compound containing an electron donor group. The resultant reaction is highly exothermic. Effective cooling of the reaction mass is essential because high temperatures promote side reactions that produce undesirable by-products. Also, precise control of the molar ratio of SO₃ to alkyl alcohol is essential because any excess SO₃, due to its reactive nature, contributes to side reactions and by-product formation. Therefore, commercial scale sulfation reactions require special equipment and instrumentation that allows tight control of the mole ratio of SO₃ to alkyl alcohol and rapid removal of the heat of reaction.

The problem of SO₃ reactivity has typically been solved by diluting and/or complexing the SO₃ to moderate the rate of reaction. Commercial diluting or complexing agents include ammonia (sulfamic acid), hydrochloric acid (chlorosulfuric acid), and dry air (air/SO₃ film sulfation). Control of the ratio of SO₃ to alkyl alcohol can be used to achieve improved product quality with use of any of these reagents.

Air/SO₃ film sulfation processes are typically carried out using a film reactor, such as an annular falling film reactor, such as a “Chemithon” reactor, or a multi-tube film reactor, such as the “Ballestra” reactor. In such processes, the SO₃ is first diluted with dry air. Such air/SO₃ sulfation processes are direct processes in which SO₃ gas is diluted with very dry air and reacted directly with the alkyl alcohol feedstock. The reaction of gaseous SO₃ with the alkyl alcohol is rapid and stoichiometric. Such processes are complicated by the possibility of side reactions, However, with tight process control, very high purity alkyl sulfate surfactants can be achieved.

The SO₃ can be provided by burning molten sulfur in an excess of oxygen to form SO₂, which is then catalytically oxidised to SO₃, for instance, at a temperature of from 400° C. to 470° C. The oxygen can be supplied by air which has been pre-dried to remove the major part of water by condensation and subsequently drying with a desiccant until the air has a maximum dewpoint of −60° C., preferably <−70° C. Considering the exothermic nature of the sulfur burning reaction, the SO₂/air flow is cooled in an indirect air cooler, prior to converting the SO₂ to SO₃ through a catalytic oxidation. Catalytic oxidation is typically done using at least one, preferably from 3 to 4 catalytic beds. An example of such a catalytic converter includes a converter tower filled with 4 packed beds of V₂O₅ catalyst on a silica carrier. Considering the exothermic nature of the SO₂ to SO₃ oxidation, an intermediate cooling of the resulting process gas is executed between the various beds through indirect air coolers, such as vertical air cooled shell and tube heat exchangers. Despite the air pre-drying step there is still some sulfuric acid/oleum mist condensed which is removed through a demister, such as a Brinks filter, prior to the sulfation step. To ensure sufficient mist is removed the gas stream at this point in the process is cooled to at least 60° C., but most preferably the gas stream is cooled to a temperature of from 30 to 55° C.

In air/SO₃ film sulfation processes, the sulfation step is typically carried out in a liquid-gas interface reactor, preferably a falling film reactor. Suitable falling film reactors include annular-gap falling film (“Chemithon”) reactors, (multi) tubular (“Ballestra”) reactors, and the like.

The blend of alkyl alkoxylated alcohols is converted through reaction with the SO₃ within the falling film reactor into alkyl alkoxylated sulfuric acid. The sulfation is typically completed to a degree of sulfation of at least 95%, preferably at least 96%, more preferably at least 98%.

Considering the exothermic nature of the sulfonation reaction, consequent cooling is again required after which the air/gas is separated from the liquid stream. Ideally the reaction mixture is maintained at the outlet of the reactor at a temperature of from 15° C. to 50° C., preferably from 30° C. and 40° C.

The air/gas can be separated from the liquid using a liquid separator. Where the separation does not remove sufficient gas from the liquid mixture, an extra degassing step can be done, for instance, by using a “Fryma” spinning disc deacrator.

The exhaust gas typically comprises small amounts of non-converted SO₂, non-reacted SO₃ and some entrained organic acid. The organic aerosol and fine SO₃/H2SO₄ droplets are typically separated from the exhaust gas flow in an electrostatic precipitator, and the gaseous SO₂ gasses are typically washed from the process air in a scrubber using a dilute caustic solution.

The formation of sulfuric acid can be minimised and a low ionic strength maintained, when the alkyl alkoxylated alcohol stream fed into the sulfation reaction preferably comprises less than 0.1%, preferably less than 0.05%, more preferably is free of water.

The sulfation can be completed to a degree of sulfation of at least 95%, preferably at least 96%, more preferably at least 98%. That is, the sulfation reaction results in a conversion of at least 95%, preferably at least 96%, more preferably at least 98% by weight of the starting alkyl alkoxylated alcohol. A degree of sulfation of 100% is typically not achieved. As such, residual amounts of unsulfated alkyl alcohol and alkyl alkoxylated alcohol are typically present. The sulfuric acid presence in the liquid stream after sulfation is typically less than 1%, preferably less than 0.75%, more preferably less than 0.5% by weight of the total liquid stream.

The unreacted alkyl alkoxylated alcohol level after sulfation is preferably below 3%, more preferably below 2.5%, and most preferably below 2% by weight of the starting alkyl sulfuric acid at the start of the neutralisation step. The amount of unreacted alkyl (alkoxylated) alcohol can be determined by GC analysis (after neutralisation of the alkyl sulfuric acid).

### Neutralisation Step:

Considering the sensitivity of protonated alkyl sulfuric acid to re-hydrolyse into the starting alkyl alcohols, a consequent neutralisation step is required. Without neutralisation, re-hydrolysis of the alkyl sulfuric acid leads to a decreased alkyl alkoxylated sulfate anionic surfactant content in the resultant concentrated surfactant blend, and also to an increased sulfuric acid content which results in discoloration of the concentrated surfactant blend and liquid detergent compositions made with the concentrated surfactant blend.

In the present process, a neutralising stream comprising at least one neutralising agent is provided. During or after the neutralisation step, the neutralising agent can be added at a level to provide the resultant concentrated surfactant blend with a pH of at least 7.0, or from 7.1 to 12, preferably from 7.3 to 9.5, more preferably from 7.5 to 9.0, measured as a 10% by weight solution of the concentrated surfactant blend in demineralized water, at 20° C.

Too low a pH can lead to re-hydrolysis of the alkyl alkoxylated sulfate anionic surfactant, while too high a pH typically complicates conversion of the concentrated surfactant blend into a finished detergent product composition, such as requiring a significant amount of acid to trim back the pH to the targeted finished product pH. In addition, too high a pH can result in the generation of 1,4-dioxanes over time, as well as higher amounts of neutralizing agent being added, increasing the salt level in the concentrated surfactant blend accordingly. Concentrated surfactant blends which comprise high salt levels are more challenging to formulate into detergent compositions, and result in a reduced low temperature stability as well as increased viscosity upon initial dissolution with water, slowing down product dissolution accordingly.

The neutralising agent is an alkali. Further neutralising agent can be added after the neutralisation step in order to adjust the pH to the desired level. Suitable alkali can be selected from the group consisting of sodium hydroxide potassium hydroxide, ammonia, mono-ethanolamine, di-ethanolamine, tri-ethanolamine, and mixtures thereof, with sodium hydroxide being most preferred. Alternatively, or in addition, other alkalis can be added as part of the neutralisation step. Particularly suitable other alkalis are alkalis that can be added to the resultant liquid detergent composition to improve performance. In particular, amines, especially cyclic polyamine having amine functionalities that helps cleaning, as described later.

The neutralisation step should be completed in less than 10 minutes, preferably less than 5 minutes and most preferably less than 2 minutes, after the sulfation step has been completed.

The neutralisation can take place in any suitable means, including in a batch reactor or by combining the alkyl sulfuric acid stream and neutralising stream using a high shear mixer. In preferred processes, a loop reactor can be used. A loop reactor is a continuous tube or pipe, typically stainless steel, which connects the outlet of a recirculation pump to its inlet. Reactants are fed into the loop where the neutralisation occurs, and the at least partially neutralised mixture is withdrawn from the loop.

As such, a loop reactor typically comprises a circulation pump, a homogenizer or high shear mixer, and a heat exchanger, due to the exothermic nature of the neutralisation reaction. Efficient mixing of the alkyl sulfuric acid stream and the neutralising stream results in instantaneous reaction and avoids undesired degradation reactions in isolated spots and pH drift occurring during the neutralisation step. As such high shear mixers are typically used considering the highly viscous nature of the resulting paste, especially at low shear rates.

As the neutralization reaction is exothermic, a heat exchanger, such as a plate and frame heat exchanger, can be used to continuously cool the mixture to achieve a temperature of less than 70° C., preferably less than 60° C. and most preferably in a range of 20 to 40° C. for the alkyl sulfate stream after neutralisation.

Water or organic solvents can be added either to control the viscosity during the neutralisation step or to improve homogenisation. Suitable organic solvents include C₁-C₄ alcohols, particularly ethanol. Such organic solvents can be added as a separate stream during the neutralisation step, or as part of the alkyl alcohol stream, or as part of the neutralisation stream. Water can be added as a separate stream during the neutralisation step, or as part of the neutralisation stream.

Water can be added at a level such that the resultant concentrated surfactant blend comprises water at a level of from 20% to 50%, preferably from 25% to 45%, more preferably from 30% to 40% by weight of the concentrated surfactant blend. The water level can be measured using any suitable means, such as via Karl Fisher Titration,

The neutralisation stream can comprise water at a level of from 35% to 80%, preferably from 45% to 75%, more preferably from 55% to 65% by weight of the neutralisation stream.

The neutralising stream can comprise other optional ingredients, such as nonionic surfactant, polymers, and peroxides, such as those described later, and mixtures thereof.

After the neutralization step the resulting neutralized surfactant paste can be transported through a transfer pump into a storage tank.

The dioxane level in the concentrated surfactant blends formed by the process of the present disclosure can be less than 40 ppm, preferably less than 30 ppm, most preferably less than 15 ppm after the neutralization step, expressed on a 100% anionic surfactant active basis measured immediately after the neutralizing step. The 1,4-dioxane level is measured within one hour of the completion of the neutralization step.

### Optional Further Steps:

### Buffering:

A buffering surfactant can be added at any suitable point before or during the neutralising step. The buffering surfactant is preferably added during the neutralization step, either as a separate buffer stream, but preferably as part of the neutralisation stream. Alternatively, the buffering surfactant can be added before the neutralisation step. The alkyl sulfuric acid and the buffering surfactant can be combined in a weight ratio of the alkyl sulfuric acid to the buffering surfactant of from 10:1 to 1:1, preferably from 8:1 to 2:1, more preferably from 6:1 to 3:1.

Suitable buffering surfactants can be an amphoteric surfactant, zwitterionic surfactant, or mixtures thereof. Suitable buffering surfactants can be selected from the group consisting of: amine oxide surfactant, betaine surfactant, and mixtures thereof, preferably amine oxide surfactant, more preferably C10-16 dimethyl amine oxide surfactant. C12-14 dimethyl amine oxide (lauryl dimethyl amine oxide) is particularly preferred. Such buffering surfactants also contribute to the performance of the resultant liquid hand dishwashing detergent. In addition, the buffering surfactant results in the concentrated surfactant blends, formed by the processes described herein, having reduced viscosity, especially when amine oxide surfactant is used as the buffering surfactant.

The buffering surfactant reduces the pH variation and pH drift when small amounts of acid are added or formed, for instance, through hydrolysis of the alkyl sulfate surfactant, or even from absorption of carbon dioxide from the air. As a result, the resultant concentrated surfactant blend can be stored at lower pH, resulting in less formation of 1,4-dioxanes and less salt being present in detergent compositions comprising the concentrated surfactant blend. As such, when the present process utilises a buffering surfactant, a lower pH for the concentrated surfactant blend can be used. As a result, lower levels of 1,4-dioxane are present in the concentrated surfactant blend. Moreover, the resultant alkyl sulfate containing concentrated surfactant blends exhibit lower rates of increase in the 1,4-dioxane by-product level upon ageing.

When added, the buffering surfactant can be added at a level to provide the resultant concentrated surfactant blend with a reserve alkalinity of greater than 0.02 when measured as a 10% by weight solution of the concentrated surfactant blend in demineralized water at 20° C., using the method as described herein, with the resultant concentrated surfactant blend having a pH of from 7.1 to 10, when measured as a 10% by weight solution of the concentrated surfactant blend in demineralized water at 20° C. Since the buffering surfactant reduces pH fluctuations and reduces or even prevents pH drift in the resultant concentrated surfactant blend, a lower pH can be used while still avoiding hydrolysis of the alkyl alkoxylated sulfate anionic surfactant. Since the concentrated surfactant blend can be kept at a lower pH, the formation of 1,4-dioxane is further reduced.

The buffering capacity is the ability to neutralize the pH and the resistance to change in it due to the small acidic or basic inputs or discharges. When a system is poorly buffered, the addition of even small amounts of an acid or a base will noticeably alter its pH, but when a system is well buffered, the same addition barely modifies its pH.

Reserve alkalinity is a measure often used industrially to indicate the amount of alkaline components present in the product. For some compositions, such as the concentrated surfactant blends disclosed herein, it is more important to know the reserve alkalinity of the blend rather than the buffer capacity, because the reserve alkalinity provides a measure of the capacity of the blend to neutralise any acid that is present or formed in-situ, and hence maintain an alkaline pH.

The buffering surfactant can be added at a level such that the resultant concentrated surfactant blend comprises the buffering surfactant at a level of from 1.0% to 25% preferably from 5.0% to 20%, more preferably from 10% to 15% by weight of the concentrated surfactant blend.

Suitable amine oxide surfactants can be linear or branched, though linear are preferred. Suitable linear amine oxides are typically water-soluble, and characterized by the formula R1-N(R2)(R3)O wherein R1 is a C8-18 alkyl, and the R2 and R3 moieties are selected from the group consisting of C1-3 alkyl groups, C1-3 hydroxyalkyl groups, and mixtures thereof. For instance, R2 and R3 can be selected from the group consisting of: methyl, ethyl, propyl, isopropyl, 2-hydroxethyl, 2-hydroxypropyl and 3-hydroxypropyl, and mixtures thereof, though methyl is preferred for one or both of R2 and R3. The linear amine oxide surfactants in particular may include linear C10-C18 alkyl dimethyl amine oxides and linear C8-C12 alkoxy ethyl dihydroxy ethyl amine oxides.

Preferably, the amine oxide surfactant is selected from the group consisting of: alkyl dimethyl amine oxide, alkyl amido propyl dimethyl amine oxide, and mixtures thereof. Alkyl dimethyl amine oxides are particularly preferred, such as C8-18 alkyl dimethyl amine oxides, or C10-16 alkyl dimethyl amine oxides (such as coco dimethyl amine oxide). Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, and mixtures thereof. C12-C14 alkyl dimethyl amine oxide, C12-14 alkyl amido propyl amine oxide, and mixtures thereof are particularly preferred.

Alternative suitable amine oxide surfactants include mid-branched amine oxide surfactants. As used herein, “mid-branched” means that the amine oxide has one alkyl moiety having nl carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 can be from 10 to 24 carbon atoms, preferably from 12 to 20, and more preferably from 10 to 16. The number of carbon atoms for the one alkyl moiety (n1) is preferably the same or similar to the number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein. The amine oxide further comprises two moieties, independently selected from a C1-3 alkyl, a C1-3 hydroxyalkyl group, or a polyethylene oxide group containing an average of from about 1 to about 3 ethylene oxide groups. Preferably, the two moieties are selected from a C1-3 alkyl, more preferably both are selected as Cl alkyl.

Alternatively, the amine oxide surfactant can be a mixture of amine oxides comprising a mixture of low-cut amine oxide and mid-cut amine oxide. The amine oxide of the composition of the present disclosure can then comprise:
a) from about 10% to about 45% by weight of the amine oxide of low-cut amine oxide of formula R1R2R3AO wherein R¹ and R2 are independently selected from hydrogen, C₁-C₄ alkyls or mixtures thereof, and R3 is selected from C10 alkyls and mixtures thereof; and
b) from 55% to 90% by weight of the amine oxide of mid-cut amine oxide of formula R4R5R6AO wherein R⁴ and R5 are independently selected from hydrogen, C₁-C₄ alkyls or mixtures thereof, and R6 is selected from C12-C16 alkyls or mixtures thereof

In a preferred low-cut amine oxide for use herein R³ is n-decyl, with preferably both R1 and R2 being methyl. In the mid-cut amine oxide of formula R4R5R6AO, R4 and R5 are preferably both methyl.

Preferably, the amine oxide comprises less than about 5%, more preferably less than 3%, by weight of the amine oxide of an amine oxide of formula R7R8R9AO wherein R7 and R⁸ are selected from hydrogen, C₁-C₄ alkyls and mixtures thereof and wherein R9 is selected from C8 alkyls and mixtures thereof. Limiting the amount of amine oxides of formula R7R8R9AO improves both physical stability and suds mileage.

Suitable zwitterionic surfactants include betaine surfactants. Such betaine surfactants includes alkyl betaines, alkylamidobetaine, amidazoliniumbetaine, sulfobetaine (INCI Sultaines) as well as the phosphobetaine, and preferably meets formula (I):

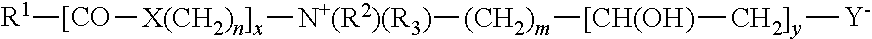

Wherein in formula (I),
R1 is selected from the group consisting of: a saturated or unsaturated C6-22 alkyl residue, preferably C8-18 alkyl residue, more preferably a saturated C10-16 alkyl residue, most preferably a saturated C12-14 alkyl residue;
X is selected from the group consisting of: NH, NR4 wherein R⁴ is a C1-4 alkyl residue, O, and S,
n is an integer from 1 to 10, preferably 2 to 5, more preferably 3,
x is 0 or 1, preferably 1,
R2 and R3 are independently selected from the group consisting of: a C1-4 alkyl residue, hydroxy substituted such as a hydroxyethyl, and mixtures thereof, preferably both R2 and R3 are methyl,
m is an integer from 1 to 4, preferably 1, 2 or 3,
y is 0 or 1, and
Y is selected from the group consisting of: COO, SO₃, OPO(OR5)O or P(O)(OR5)O, wherein R5 is H or a C1-4 alkyl residue.

Preferred betaines are the alkyl betaines of formula (Ia), the alkyl amido propyl betaine of formula (Ib), the sulfobetaine of formula (Ic) and the amido sulfobetaine of formula (Id):

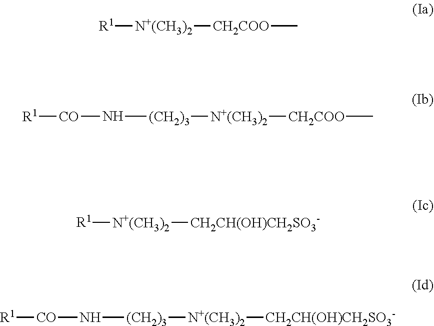

in which R1 has the same meaning as in formula (I). Particularly preferred are the carbobetaines [i.e, wherein Y—═COO— in formula (I)] of formulae (Ia) and (Ib), more preferred are the alkylamidobetaine of formula (Ib).

Suitable betaines can be selected from the group consisting or [designated in accordance with INCI]: capryl/capramidopropyl betaine, cetyl betaine, cetyl amidopropyl betaine, cocamidoethyl betaine, cocamidopropyl betaine, cocobetaines, decyl betaine, decyl amidopropyl betaine, hydrogenated tallow betaine/amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kernelamidopropyl betaine, stearamidopropyl betaine, stearyl betaine, tallowamidopropyl betaine, tallow betaine, undecylenamidopropyl betaine, undecyl betaine, and mixtures thereof. Preferred betaines are selected from the group consisting of: cocamidopropyl betaine, cocobetaines, lauramidopropyl betaine, lauryl betaine, myristyl amidopropyl betaine, myristyl betaine, and mixtures thereof. Cocamidopropyl betaine is particularly preferred.

The buffering surfactant can be added in a stream which further comprises peroxide, especially where amine oxide is used as a buffering surfactant. The peroxide can be present such that the stream comprising the buffering surfactant has a residual peroxide level of from 5.0 ppm to 300 ppm, preferably from 40 ppm to 80 ppm for every one part by weight of buffering surfactant. It is believed that the presence of peroxide further limits the formation and growth of 1,4-dioxane within the concentrated surfactant blend formed by the present process, when the concentrated surfactant blend comprises ethoxylated alkyl sulfate surfactant.

The resultant concentrated surfactant blend can comprise from 1.0 wt % to 25 wt %, preferably from 5.0 wt % to 20 wt %, more preferably from 10 wt % to 15 wt % by weight of the blend of the buffering surfactant. When present, the buffering surfactant buffers the pH of the concentrated surfactant blend without requiring additional salts to be introduced into the blend. As such, the concentrated surfactant blend resists changes in pH due to the addition or formation of an acid (or base). The resultant buffering reduces the risk of hydrolysis of the alkyl sulfate surfactant due to lowering pH, for example, upon ageing in contact with air, lowering the alkyl sulfate concentration but also resulting in the formation of by-products which cause browning of the concentrated surfactant blend (such as HSO₄_{^{−}}). Moreover, without the buffering, a higher pH would be required for the concentrated surfactant blend, in order to avoid the pH dropping over time to a level that hydrolysis of the alkyl sulfate surfactant occurs too rapidly. The need to add additional alkali results in a higher ionic strength for unbuffered concentrated surfactant blends. This leads to reduced processability of the concentrated surfactant blend, as well as reduced dispersibility upon dilution, lower viscosity, as well as reduced foaming and suds mileage for compositions comprising such unbuffered concentrated surfactant blends.

Buffers for a given application must be effective at the desired pH, and must also provide sufficient buffer capacity to maintain the desired pH as needed. In order to inhibit hydrolysis and minimise the formation of 1,4-dioxanes, the resultant concentrated surfactant blend, formed by the processes described herein, preferably have a buffer region of from a pH of 7.0 to 7.8.

A measure of the efficacy of the buffering system is provided by the reserve alkalinity. The reserve alkalinity is essentially the ability of the composition to neutralise acidic residues that are formed in the composition, such as by the hydrolysis of the alkyl sulfate surfactant. The buffering surfactant is added at a level to provide the resultant concentrated surfactant blend with a reserve alkalinity of greater than 0.02, preferably from 0.04 to 0.50, more preferably from 0.06 to 0.30 when measured as a 10% by weight solution of the concentrated surfactant blend in demineralized water at 20° C., using the method described herein.

The alkyl alkoxylated sulfate anionic surfactant and the buffering surfactant can be present in the concentrated surfactant blend in a weight ratio of from 10:1 to 1:1, preferably from 8:1 to 2:1, more preferably from 6:1 to 3:1.

### 1,4-Dioxane Removal:

The level of 1,4-dioxane can be further reduced through stripping means, such as steam stripping. If used, a multi-step stripping process is typically utilized, usually involving 2 to 3 stripping steps. Such strippers are known in the art, and include steam strippers, for example, the Dioxane Removal System (DRS) provided by Chemithon. The concentrated surfactant blend is fed directly to the 1,4-dioxane stripping unit directly after the neutralisation step. The blend is injected into the top of a single-stage stripper. Steam is also injected into the top of the stripper at a rate proportional to the amount of 1,4-dioxane being stripped from the blend. Typically, 0.5 kilograms of steam are required per kilogram of neutralised paste to achieve an 8 to 1 reduction. Subsequently, the resultant mixture is passed to a separation tank. When the steam and 1,4-dioxane leave the separation tank through a vacuum system, the condensate and 1,4-dioxane are recovered. The stripping unit is typically jacketed to maintain the temperature in the desired range and the operating pressure is carefully controlled to avoid either concentrating or diluting the paste. Tempered water (hot water that has been cooled by adding cold water with a mixing device so that the water temperature is between 35° C. and 40° C.) can also be added to the stripper shell when stripping 1,4-dioxane.

Such strippers can reduce the level of 1,4-dioxane by-product by a factor of up to 8 for each stripping step. Hence, further reductions in 1,4-dioxane by-product can be achieved using a two stage, or even three stage stripping process. Since the final level of 1,4-dioxane in the concentrated surfactant blend is lower after stripping when the level of the dioxane by-product is lower in the blend before stripping, it is preferred to minimize the level of 1,4-dioxane in the concentrated surfactant blend, even if subsequent dioxane stripping is envisioned. The resultant concentrated surfactant blend undergoes a subsequent 1,4-dioxane stripping step, wherein the 1,4-dioxane level is further reduced to less than 10 ppm, preferably less than 5.0 ppm, most preferably less than 1.0 ppm, expressed on a 100% anionic surfactant active basis. The 1,4-dioxane level is measured within one hour of the completion of the stripping step.

### Other Steps:

If desired, adjunct ingredients as described below can also be added prior to, during or after neutralisation, for instance, to simplify making of the final liquid detergent composition. Other optional ingredients include water, organic solvents, pH modifier, further surfactants, polymers, amines, preservatives, and mixtures thereof. Suitable further surfactants include further anionic surfactants, nonionic surfactants, and mixtures thereof.

### Alkyl Sulfate Containing Concentrated Surfactant Blend:

The resultant concentrated surfactant blend can comprise anionic surfactant at a level of from 20% to 80%, preferably from 20% to 40% or from 65% to 70%, most preferably from 20% to 30% by weight of the concentrated surfactant blend.

The anionic surfactant comprises, and preferably consists of, alkyl alkoxylated sulfate anionic surfactant. The alkyl alkoxylated sulfate anionic surfactant has a mol average degree of alkoxylation of less than 2.0, preferably from 0.1 to 2.0, more preferably from 0.2 to 1.5, most preferably from 0.4 to 0.9. The alkoxylation of the alkyl alkoxylated alcohol in the alkyl alkoxylated alcohol stream can be selected from ethoxylation, propoxylation, and a mixture thereof, preferably wherein the alkoxylation consists of ethoxylation.

The concentrated surfactant blend can comprise further surfactants. Suitable further surfactants include further anionic surfactants such as sulfonate anionic surfactants such as HLAS, or sulfosuccinate anionic surfactants. However, in preferred processes, the amount of such further anionic surfactants is kept low. In more preferred processes, no further anionic surfactant is added. Therefore, the concentrated surfactant blend can comprise at least 70%, preferably at least 85%, more preferably 100% by weight of the anionic surfactant of the alkyl alkoxylated sulfate anionic surfactant. The concentrated surfactant blend is preferably free of fatty acid or salt thereof, since such fatty acids impede the generation of suds.

Suitable further surfactants include nonionic surfactants. The concentrated surfactant blend can further comprise a nonionic surfactant. Suitable nonionic surfactants include alkoxylated alcohol nonionic surfactants, alkyl polyglucoside nonionic surfactants, and mixtures thereof.

The concentrated surfactant blend can comprise from 1% to 25%, preferably from 1.25% to 20%, more preferably from 1.5% to 15%, most preferably from 1.5% to 5%, by weight of the total surfactant within the concentrated surfactant blend, of an alkoxylated alcohol non-ionic surfactant.

Preferably, the alkoxylated alcohol non-ionic surfactant is a linear or branched, primary or secondary alkyl alkoxylated non-ionic surfactant, preferably an alkyl ethoxylated non-ionic surfactant, preferably comprising on average from 9 to 15, preferably from 10 to 14 carbon atoms in its alkyl chain and on average from 5 to 12, preferably from 6 to 10, most preferably from 7 to 8, units of ethylene oxide per mole of alcohol.

The concentrated surfactant blend can comprise alkyl polyglucoside (“APG”) surfactant. The addition of alkyl polyglucoside surfactants has been found to improve sudsing beyond that of comparative nonionic surfactants such as alkyl ethoxylated nonionic surfactants. If present, the alkyl polyglucoside can be present in the concentrated surfactant blend at a level of from 0.5% to 20%, preferably from 0.75% to 15%, more preferably from 1% to 10%, most preferably from 1% to 5% by weight of the total surfactant within the concentrated surfactant blend. Preferably the alkyl polyglucoside surfactant is a C8-C16 alkyl polyglucoside surfactant, preferably a C8-C14 alkyl polyglucoside surfactant. The alkyl polyglucoside preferably has an average degree of polymerization of between 0.1 and 3, more preferably between 0.5 and 2.5, even more preferably between 1 and 2. Most preferably, the alkyl polyglucoside surfactant has an average alkyl carbon chain length between 10 and 16, preferably between 10 and 14, most preferably between 12 and 14, with an average degree of polymerization of between 0.5 and 2.5 preferably between 1 and 2, most preferably between 1.2 and 1.6.

C8-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation).

Alternatively, the concentrated surfactant blend is free of other surfactants than anionic surfactant, most preferably wherein the anionic surfactant consists of the alkoxylated, preferably ethoxylated alkyl sulfate, and optionally non-alkoxylated alkyl sulfate.

The concentrated surfactant blend can be Newtonian or non-Newtonian, preferably Newtonian. The surfactant blend can have a viscosity of from 5,000 mPa·s to 25,000 mPa's, preferably from 7,500 mPa·s to 20,000 mPa·s, most preferably from 10,000 mPa·s to 15,000 mPa·s, measured at a shear rate of 10 s⁻¹ and a temperature of 20° C.

The concentrated surfactant blend can have a flow index of from 0.1 to 1.0, preferably from 0.2 to 0.5, more preferably from 0.2 to 0.4. The concentrated surfactant blend can have a yield stress of from 5.0 Pa to 30 Pa, preferably from 10 Pa to 25 Pa, more preferably from 15 Pa to 20 Pa. The aforementioned flow index and yield stress result in improved processibility of the concentrated surfactant blend.

The melting point of the concentrated surfactant blend is preferably less than 20° C., more preferably less than 15° C., most preferably less than 10° C. so that the concentrated surfactant blend can be stored at ambient temperatures and not require heating in order to process into a detergent composition. The melting point can be measured using Differential Scanning calorimetry” (DSC).

The concentrated surfactant blend can have a density in the range from 500 kg/m3 to 1,500 kg/m3, preferably from 750 kg/m3 to 1,250 kg/m3, more preferably from 1,000 kg/m3 to 1,100 kg/m3, measured at a temperature of 20° C. The density can be measured using any suitable means, such as using a pycnometer.

### Liquid Hand Dishwashing Composition:

The concentrated surfactant blends, as described herein can be used to make liquid detergent compositions, especially liquid hand dishwashing detergent composition.

The term “dishware” and “dish” as used herein includes cookware and tableware made from, by non-limiting examples, ceramic, china, metal, glass, plastic (e.g., polyethylene, polypropylene, polystyrene, etc.) and wood.

The cleaning composition is a liquid cleaning composition, preferably a liquid hand dishwashing cleaning composition, and hence is in liquid form. The liquid cleaning composition is preferably an aqueous cleaning composition. As such, the composition can comprise from 50% to 85%, preferably from 50% to 75%, by weight of the total composition of water.

The liquid cleaning composition has a pH greater than 6.0, or a pH of from 6.0 to 12.0, preferably from 7.0 to 11.0, more preferably from 8.0 to 10.0, measured as a 10% aqueous solution in demineralized water at 20 degrees ° C.

When the pH exceeds a pH of 7.0, the reserve alkalinity can be from 0.1 to 1.0, more preferably from 0.1 to 0.5. Reserve alkalinity is herein expressed as grams of NaOH/100 ml of composition required to titrate product from a pH 7.0 to the pH of the finished composition. This pH and reserve alkalinity further contribute to the cleaning of tough food soils.

The liquid cleaning composition of the present disclosure can be Newtonian or non-Newtonian, preferably Newtonian. Preferably, the composition has a viscosity of from 10 mPa's to 10,000 mPa·s, preferably from 100 mPa·s to 5,000 mPa·s, more preferably from 300 mPa·s to 2,000 mPa·s, or most preferably from 500 mPa·s to 1,500 mPa·s, alternatively combinations thereof. The viscosity is measured at 20° C. with a Brookfield RT Viscometer using spindle 31 with the RPM of the viscometer adjusted to achieve a torque of between 40% and 60%.

The liquid cleaning composition can comprise the concentrated surfactant blend and optionally additional surfactant, such that the composition comprises from 5.0% to 50%, preferably from 6.0% to 40%, most preferably from 15% to 35%, by weight of the total composition of a surfactant system.

The liquid hand dishwashing detergent composition comprises anionic surfactant that is comprised in the concentrated surfactant blend used to make the detergent composition. Preferably, the liquid hand dishwashing detergent composition does not comprise any further anionic surfactant.

The liquid hand dishwashing detergent composition can comprise a co-surfactant. The co-surfactant can be the optional buffering surfactant, when comprised in the concentrated surfactant blend used to make the detergent composition. Alternatively, or in addition, co-surfactant can be added, in addition to any co-surfactant comprised in the concentrated surfactant blend. The co-surfactant can include one or more amphoteric or zwitterionic surfactant, added to the detergent composition, in addition to the concentrated surfactant blend, described herein. The liquid hand dishwashing detergent composition can comprise nonionic surfactant. Suitable nonionic surfactants include alkoxylated alcohol nonionic surfactants, alkyl polyglucoside nonionic surfactants, and mixtures thereof, as described earlier. Such nonionic surfactant can be added as part of the concentrated surfactant blend used to make the detergent composition, or can be added separately and in addition to the concentrated surfactant blend, or both.

The composition can comprise further ingredients such as those selected from: amphiphilic alkoxylated polyalkyleneimines, cyclic polyamines, triblock copolymers, inorganic mono-, di- or trivalent salts, hydrotropes, organic solvents, other adjunct ingredients such as those described herein, and mixtures thereof. Such ingredients can be added as part of the surfactant blend, or separately added, in addition to the surfactant blend.

### Amphiphilic Alkoxylated Polyalkyleneimine:

The composition of the present disclosure may further comprise from 0.05% to 2%, preferably from 0.07% to 1% by weight of the total composition of an amphiphilic polymer. Suitable amphiphilic polymers can be selected from the group consisting of: amphiphilic alkoxylated polyalkyleneimine and mixtures thereof. The amphiphilic alkoxylated polyalkyleneimine polymer has been found to improve grease removal.

A preferred amphiphilic alkoxylated polyethyleneimine polymer has the general structure of formula (I):

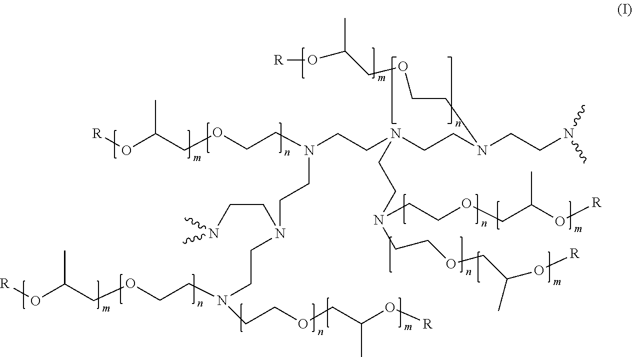

wherein the polyethyleneimine backbone has a weight average molecular weight of 600, n of formula (I) has an average of 10, m of formula (I) has an average of 7 and R of formula (I) is selected from hydrogen, a C₁-C₄ alkyl and mixtures thereof, preferably hydrogen. The degree of permanent quaternization of formula (I) may be from 0% to 22% of the polyethyleneimine backbone nitrogen atoms. The molecular weight of this amphiphilic alkoxylated polyethyleneimine polymer preferably is between 10,000 and 15,000 Da.

More preferably, the amphiphilic alkoxylated polyethyleneimine polymer has the general structure of formula (I) but wherein the polyethyleneimine backbone has a weight average molecular weight of 600 Da, n of Formula (I) has an average of 24, m of Formula (I) has an average of 16 and R of Formula (I) is selected from hydrogen, a C₁-C₄ alkyl and mixtures thereof, preferably hydrogen. The degree of permanent quaternization of Formula (I) may be from 0% to 22% of the polyethyleneimine backbone nitrogen atoms and is preferably 0%. The molecular weight of this amphiphilic alkoxylated polyethyleneimine polymer preferably is between 25,000 and 30,000, most preferably 28,000 Da.

The amphiphilic alkoxylated polyethyleneimine polymers can be made by the methods described in more detail in PCT Publication No. WO 2007/135645.

### Cyclic Polyamine

The composition can comprise a cyclic polyamine having amine functionalities that helps cleaning. The composition of the present disclosure preferably comprises from 0.1% to 3%, more preferably from 0.2% to 2%, and especially from 0.5% to 1%, by weight of the composition, of the cyclic polyamine.

The cyclic polyamine has at least two primary amine functionalities. The primary amines can be in any position in the cyclic amine but it has been found that in terms of grease cleaning, better performance is obtained when the primary amines are in positions 1,3. It has also been found that cyclic amines in which one of the substituents is —CH3 and the rest are H provided for improved grease cleaning performance.

Accordingly, the most preferred cyclic polyamine for use with the cleaning composition of the present disclosure are cyclic polyamine selected from the group consisting of: 2-methylcyclohexane-1,3-diamine, 4-methylcyclohexane-1,3-diamine and mixtures thereof. These specific cyclic polyamines work to improve suds and grease cleaning profile through-out the dishwashing process when formulated together with the surfactant system of the composition of the present disclosure.

Suitable cyclic polyamines can be supplied by BASF, under the Baxxodur tradename, with Baxxodur ECX-210 being particularly preferred.

A combination of the cyclic polyamine and magnesium sulfate is particularly preferred. As such, the composition can further comprise magnesium sulfate at a level of from 0.001% to 2.0%, preferably from 0.005% to 1.0%, more preferably from 0.01% to 0.5% by weight of the composition.

### Triblock Copolymer

The composition of the present disclosure can comprise a triblock copolymer. The triblock co-polymers can be present at a level of from 0.1% to 10%, preferably from 0.5% to 7.5%, more preferably from 1% to 5%, by weight of the total composition. Suitable triblock copolymers include alkylene oxide triblock co-polymers, defined as a triblock co-polymer having alkylene oxide moieties according to Formula (I): (EO)x(PO)y(EO)x, wherein EO represents ethylene oxide, and each x represents the number of EO units within the EO block. Each x can independently be on average of from 5 to 50, preferably from 10 to 40, more preferably from 10 to 30. Preferably x is the same for both EO blocks, wherein the “same” means that the x between the two EO blocks varies within a maximum 2 units, preferably within a maximum of 1 unit, more preferably both x's are the same number of units. PO represents propylene oxide, and y represents the number of PO units in the PO block. Each y can on average be from between 28 to 60, preferably from 30 to 55, more preferably from 30 to 48.

Preferably the triblock co-polymer has a ratio of y to each x of from 3:1 to 2:1. The triblock co-polymer preferably has a ratio of y to the average x of 2 EO blocks of from 3:1 to 2:1. Preferably the triblock co-polymer has an average weight percentage of total EO of between 30% and 50% by weight of the tri-block co-polymer. Preferably the triblock co-polymer has an average weight percentage of total PO of between 50% and 70% by weight of the triblock co-polymer. It is understood that the average total weight % of EO and PO for the triblock co-polymer adds up to 100%. The triblock co-polymer can have an average molecular weight of between 2060 and 7880, preferably between 2620 and 6710, more preferably between 2620 and 5430, most preferably between 2800 and 4700. Average molecular weight is determined using a 1H NMR spectroscopy (see Thermo scientific application note No. AN52907).

Triblock co-polymers have the basic structure ABA, wherein A and B are different homopolymeric and/or monomeric units. In this case A is ethylene oxide (EO) and B is propylene oxide (PO). Those skilled in the art will recognize the phrase “block copolymers” is synonymous with this definition of “block polymers”.

Triblock co-polymers according to Formula (I) with the specific EO/PO/EO arrangement and respective homopolymeric lengths have been found to enhance suds mileage performance of the liquid hand dishwashing detergent composition in the presence of greasy soils and/or suds consistency throughout dilution in the wash process.

Suitable EO-PO-EO triblock co-polymers are commercially available from BASF such as Pluronic® PE series, and from the Dow Chemical Company such as Tergitol™ L series. Particularly preferred triblock co-polymer from BASF are sold under the tradenames Pluronic® PE6400 (MW ca 2900, ca 40 wt % EO) and Pluronic® PE 9400 (MW ca 4600, 40 wt % EO). Particularly preferred triblock co-polymer from the Dow Chemical Company is sold under the tradename Tergitol™ L64 (MW ca 2700, ca 40 wt % EO).

Preferred triblock co-polymers are readily biodegradable under aerobic conditions.

The composition of the present disclosure may further comprise at least one active selected from the group consisting of: salt, hydrotrope, organic solvent, and mixtures thereof.

### Salt:

The composition of the present disclosure may comprise from 0.05% to 2%, preferably from 0.1% to 1.5%, or more preferably from 0.5% to 1%, by weight of the total composition of a salt, preferably a monovalent or divalent inorganic salt, or a mixture thereof, more preferably selected from: sodium chloride, sodium sulfate, and mixtures thereof. Sodium chloride is most preferred.

### Hydrotrope:

The composition of the present disclosure may comprise from 0.1% to 10%, or preferably from 0.5% to 10%, or more preferably from 1% to 10% by weight of the total composition of a hydrotrope or a mixture thereof, preferably sodium cumene sulfonate.

### Organic Solvent:

The composition can comprise from 0.1% to 10%, or preferably from 0.5% to 10%, or more preferably from 1% to 10% by weight of the total composition of an organic solvent. Suitable organic solvents include organic solvents selected from the group consisting of: alcohols, glycols, glycol ethers, and mixtures thereof, preferably alcohols, glycols, and mixtures thereof. Ethanol is the preferred alcohol. Polyalkyleneglycols, especially polypropyleneglycol (PPG), are the preferred glycol. The polypropyleneglycol can have a molecular weight of from 400 to 3000, preferably from 600 to 1500, more preferably from 700 to 1300. The polypropyleneglycol is preferably poly-1,2-propyleneglycol.

### Adjunct Ingredients

The cleaning composition may optionally comprise a number of other adjunct ingredients such as builders (preferably citrate), further chelants, conditioning polymers, other cleaning polymers, surface modifying polymers, structurants, emollients, humectants, skin rejuvenating actives, enzymes, carboxylic acids, scrubbing particles, perfumes, malodor control agents, pigments, dyes, opacifiers, pearlescent particles, inorganic cations such as alkaline earth metals such as Ca/Mg-ions, antibacterial agents, preservatives, antioxidants, viscosity adjusters (e.g., salt such as NaCl, and other mono-, di- and trivalent salts) and pH adjusters and buffering means (e.g. carboxylic acids such as citric acid, HCl, NaOH, KOH, alkanolamines, carbonates such as sodium carbonates, bicarbonates, sesquicarbonates, and alike).

If present, the composition comprises from 0.01% to 2.0%, preferably from 0.05% to 1.5%, or more preferably from 0.1% to 1.0%, by weight of alkaline earth metal ions, with magnesium and/or calcium ions being particularly preferred. Low levels of transition metal ions can also be present in the liquid detergent composition, such as up to 1.0%, or up to 0.5% by weight of the composition.

### Packaged Product

The hand dishwashing detergent composition can be packaged in a container, typically plastic containers. Suitable containers comprise an orifice. Typically, the container comprises a cap, with the orifice typically comprised on the cap. The cap can comprise a spout, with the orifice at the exit of the spout. The spout can have a length of from 0.5 mm to 10 mm.

The orifice can have an open cross-sectional surface area at the exit of from 3 mm² to 20 mm², preferably from 3.8 mm² to 12 mm², more preferably from 5 mm² to 10 mm², wherein the container further comprises the composition according to the present disclosure. The cross-sectional surface area is measured perpendicular to the liquid exit from the container (that is, perpendicular to the liquid flow during dispensing).

The container can typically comprise from 200 ml to 5,000 ml, preferably from 350 ml to 2000 ml, more preferably from 400 ml to 1,000 ml of the liquid hand dishwashing detergent composition.

Alternatively, the hand dishwashing detergent composition can be packaged in an inverted container. Such inverted containers typically comprise a cap at the bottom of the container, the cap comprising either a closure or a self-sealing valve, or a combination thereof. The cap preferably comprises a self-sealing valve. Suitable self-sealing valves include slit-valves. The self-scaling valve defines a dispensing orifice that opens when the pressure on the valve interior side sufficiently exceeds the pressure on the valve exterior side. The bottom dispensing container can comprise an impact resistance system, such as that described in WO2019108293A1.

### Method of Washing

The resultant liquid detergent compositions can be used for manually washing. Suitable methods can comprise the steps of delivering such a liquid detergent composition to a volume of water to form a wash solution and immersing the dishware in the solution. The dishware is be cleaned with the composition in the presence of water. The dishware can be rinsed. By “rinsing”, it is meant herein contacting the dishware cleaned with the process according to the present disclosure with substantial quantities of appropriate solvent, typically water. By “substantial quantities”, it is meant usually about 1 to about 20 L, or under running water.

The composition herein can be applied in its diluted form. Soiled dishware are contacted with an effective amount, typically from about 0.5 mL to about 20 mL (per about 25 dishes being treated), preferably from about 3 mL to about 10 mL, of the cleaning composition, preferably in liquid form, of the present disclosure diluted in water. The actual amount of cleaning composition used will be based on the judgment of the user and will typically depend upon factors such as the particular product formulation of the cleaning composition, including the concentration of active ingredients in the cleaning composition, the number of soiled dishes to be cleaned, the degree of soiling on the dishes, and the like. Generally, from about 0.01 mL to about 150 mL, preferably from about 3 mL to about 40 mL of a cleaning composition of the present disclosure is combined with from about 2,000 mL to about 20,000 mL, more typically from about 5,000 mL to about 15,000 mL of water in a sink. The soiled dishware is immersed in the sink containing the diluted cleaning compositions then obtained, before contacting the soiled surface of the dishware with a cloth, sponge, or similar cleaning implement. The cloth, sponge, or similar cleaning implement may be immersed in the cleaning composition and water mixture prior to being contacted with the dishware, and is typically contacted with the dishware for a period of time ranged from about 1 to about 10 seconds, although the actual time will vary with each application and user. The contacting of cloth, sponge, or similar cleaning implement to the dishware is accompanied by a concurrent scrubbing of the dishware.

Preferably, the composition is applied in its neat form to the dish to be treated. By “in its neat form”, it is meant herein that said composition is applied directly onto the surface to be treated, or onto a cleaning device or implement such as a brush, a sponge, a nonwoven material, or a woven material, without undergoing any significant dilution by the user (immediately) prior to application. Application using a sponge is preferred. “In its neat form”, also includes slight dilutions, for instance, arising from the presence of water on the cleaning device, or the addition of water by the consumer to remove the remaining quantities of the composition from a bottle. Therefore, the composition in its neat form includes mixtures having the composition and water at ratios ranging from 50:50 to 100:0, preferably 70:30 to 100:0, more preferably 80:20 to 100:0, even more preferably 90:10 to 100:0 depending on the user habits and the cleaning task.

### Test Methods

### A) pH:

The pH is measured as a 10% aqueous solution in demineralized water at 20° C., using a PH meter, such as an Orion Model 720A with an Ag/AgCl electrode (for example an Orion sure flow Electrode model 9172BN), calibrated using standardized pH 7 and pH 10 buffers.

### B) Reserve Alkalinity:

Reserve alkalinity is defined as the grams of NaOH per 100 g of composition required to titrate the test composition at pH 7.0 to come to the test composition pH. The reserve alkalinity for a solution is determined in the following manner.

The reserve alkalinity is measured at a 10% solution of the concentrated surfactant blend in deionized water at 20° C. As such, 50 g of the concentrated surfactant blend is diluted to 10% with deionized water and mixed for 5 minutes until fully homogenized. 100 g of the 10% solution is then titrated using an automated titrator, such as the Omnis sample robot and Omnis titrator, supplied by Metrohm, using 0.1 N hydrochloric acid (HCl) and PH meter (as above), until an end-point of pH 4 is achieved or the maximum titration amount of the titrator is reached (25 ml for the titrator above). The volume of the titrant required to reach a pH of 7.0 is recorded, or if the maximum titration amount is reached, the final pH and volume of titrant is recorded.

The reserve alkalinity is calculated as follows:

Reserve Alkalinity=ml 0.1N HCl required to reach a pH of 7.0×0.1 (equivalent/liter)×Equivalent weight NaOH (g/equivalent)×10.

Where the maximum titration amount from the titrator has been reached, the final pH is recorded and the reserve alkalinity to this pH is calculated. The reserve alkalinity to pH 7.0 can then be estimated through linear extrapolation to pH 7.0 of the obtained “pH versus volume titrant” titration curves between an added titrant volume of 20 ml and 25 ml.

### C) 1,4-Dioxane Measurement in the Concentrated Surfactant Blend:

The 1,4 dioxane is separated from the other components in the concentrated surfactant blend using steam distillation. The amount of 1,4-dioxane in the distillate is then measured using gas chromatography, using a flame ionization detector (GC-FID), through comparison versus a 1,3-dioxane internal reference standard.

The steam distillation is carried out using a distillation unit, such as a Foss Kjeltec™ 8100 fitted with an 800 mL distillation reservoir. The weight of the concentrated surfactant blend sample to be subjected to steam distillation depends on the expected level of 1,4-dioxane within the concentrated surfactant blend (expressed as μg 1,4-dioxane/g 100% anionic surfactant active).

TABLE 1
amount of starting concentrated surfactant blend sample

| Expected 1,4-dioxane level | Recommended sample volume |
|---|---|
| (μg/g) | (g) |
| <5 | 100 |
| 5-10 | 75 |
| 10-50 | 50 |
| 50-100 | 25 |
| >100 | 10 |

The above sample volume of the concentrated surfactant blend is added to the distillation flask, together with 1 ml of a 1,3-dioxane solution (0.25 g 1,3-dioxane/100 ml distilled water) as the internal reference standard and 0.5 ml of a silicone antifoam (Available from Foss Product, number 67165, JTBaker B531-05).

Steam distillation is completed by the automatic addition of 100 ml distilled water at room temperature, followed by steam injection until 180 ml to 200 ml of distillate has been collected within 6 to 10 minutes of continuous addition of steam.

1 ml of the distillate is then analysed via a gas chromatography (GC-FID, using an Agilent 6890, fitted with an OVI-G43, 30 m×0.53 mm×3 um film Supelco column catalogue number 25396, Restek liner catalogue number 20987, and flame ionization detector), with the following settings:

| Inlet | | |
|---|---|---|
| Mode | Pulsed Splitless | |
| Temperature | 180° | C. |
| Constant flow | 5 mL/min at 0.266 bar (3.86 psi), 37 cm/sec | |
| Pulse Pressure | 0.689 bar (10.0 psi) | |
| Pulse time | 1.00 | min |
| Purge flow | 100.0 | mL/min |
| Purge time | 0.15 | min |
| Total Flow | 107.7 | mL/min (approximate) |
| Gas Saver | On 15 mL/min @ 2 min | |
| Carrier Gas | Helium (Hydrogen or /Nitrogen can also be | |
| | used with no changes to above parameters) | |
| Oven | | |
| Initial temperature | 50° C.; hold for 1 minute | |
| Ramp #1 | 5° C./min to 100° C.; hold for 0.5 minutes | |
| Ramp #2 | 25° C./min to 210° C.; hold for 1.1 minutes | |
| Total run time | 17 | min |
| Column | | |
| Injection volume | 0.5 | μl |
| Detector | | |
| Temperature | 260° | C. |

| | |
|---|---|
| Hydrogen | 40 mL/min (or as recommended by manufacturer) |
| Air | 450 mL/min (or as recommended by manufacturer) |
| Makeup flow | 45 mL/min (constant column + makeup flow) |
| (Helium) | (or as recommended by manufacturer) |

The 1,4-dioxane level in the concentrated surfactant blend is determined by comparing the area ratio of the 1,4-dioxane/1,3-dioxane for the test sample versus a 1,4-dioxane/1,3-dioxane calibration curve. The resulting 1,4-dioxane level was then normalized to 100% active surfactant level by taking the measured 1,4-dioxane ppm level within the concentrated surfactant blend, dividing it by the surfactant weight % active level and multiplying it by 100 to obtain the final value expressed as ppm1,4-dioxane/100% surfactant active.

### D) Concentrated Surfactant Blend Viscosity:

The rheology profile is measured using a “TA instruments DHR1” rheometer, using a cone and plate geometry with a flat steel Peltier plate and a 40 mm diameter, 2.008° cone (TA instruments, serial number: SN999393). The viscosity measurement procedure includes a conditioning step and a sweep step at 20° C. The conditioning step takes place at 20° C. and consists of 10 seconds at zero shear, followed by pre-shearing for 10 seconds at 10 s⁻¹, followed by 30 seconds at zero shear in order for the sample to equilibrate.

An upwards shear rate sweep is conducted from a shear rate of from 0.1s⁻¹ to 100s⁻¹, in increments of 10 points per decade, each incremental step is executed by the rheometer automatically after stabilisation of the measurement. Unless otherwise stated, the viscosity is measured at shear rate of 10 s⁻¹ and a temperature of 20° C.

### E) Flow Index and Yield Stress of the Concentrated Surfactant Blend:

As with the viscosity measurements of the concentrated surfactant blends, the rheology profile is measured using a “TA instruments DHR1” rheometer, using a cone and plate geometry with a flat steel Peltier plate and a 40 mm diameter, 2.008° cone (TA instruments, serial number: SN999393). The viscosity measurement procedure includes a conditioning step and a sweep step at 20° C. The conditioning step takes place at 20° C. and consists of 10 seconds at zero shear, followed by pre-shearing for 10 seconds at 10 s⁻¹, followed by 30 seconds at zero shear in order for the sample to equilibrate.

An upwards shear rate sweep is conducted from a shear rate of from 0.1s⁻¹ to 100s⁻¹, in increments of 10 points per decade, each incremental step is executed by the rheometer automatically after stabilisation of the measurement.

The shear stress is recorded as a function of shear rate by the rheometer. The data is then fitted to the Herschley Buckley model: τ=τ₀+Kγⁿ, where “τ” is the shear stress, “τ₀” is the yield stress, and is γ the shear rate. “K” is the consistency index, and “n” is the flow index.

F) Concentrated Surfactant Blend Viscosity Variation with Temperature:

The rheology variation with temperature is measured using a “TA instruments DHR1” rheometer, using a cone and plate geometry with a flat steel Peltier plate and a 40 mm diameter, 2.026° cone (TA instruments, serial number: SN999393), at a shear rate of 10s⁻¹ and a temperature sweep of from 60° C. down to 5° C. using a temperature ramp of 2° C./min, after a 100 second equilibration step at a shear rate of 10s⁻¹ at 60° C.

### G) Detergent Composition Viscosity Measurement:

The viscosity of a detergent composition is measured at 20° C. with a Brookfield RT Viscometer using spindle 31 with the RPM of the viscometer adjusted to achieve a torque of between 40% and 60%.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any example disclosed or claimed herein or that it alone, or in any combination with any other reference or references, teaches, suggests or discloses any such example. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of the present disclosure.

What is claimed is:

1. A process for making a concentrated surfactant blend, wherein the concentrated surfactant blend comprises a blend of alkyl alkoxylated sulfate anionic surfactants, wherein the process comprises the following steps:
a. a blending step wherein:
i. at least two different alkoxylate alcohols having a mol average degree of alkoxylation of about 2.0 or less are blended together, to provide an alkyl alkoxylated alcohol stream, wherein:
the at least two different alkoxylated alcohols have a mol average degree of alkoxylation which differs by no more than about 0.5; and
the starting alkyl alcohols used to produce the at least two different alkyl alkoxylated alcohols differ in chain length distribution, average degree of branching, branching distribution, or a combination thereof; or
ii. at least two alkyl alcohols are blended together to provide an alkyl alcohol stream, wherein the at least two alkyl alcohols differ in chain length distribution, average degree of branching, branching distribution, or a combination thereof; and the alkyl alcohol stream is alkoxylated to a mol average degree of alkoxylation of about 2.0 or less, to provide an alkyl alkoxylated alcohol stream;
b. a sulfation step, during which the alkyl alkoxylated alcohol stream is sulfated to provide an alkyl alkoxylated sulfuric acid stream;
c. a neutralisation step, during which the alkyl alkoxylated sulfuric acid stream is neutralised, wherein: the resultant concentrated surfactant blend has a pH of at least about 7.0 when measured as an about 10% by weight solution of the concentrated surfactant blend in demineralized water at about 20° C.

2. The process according to claim 1, wherein the resultant concentrated surfactant blend comprises the anionic surfactant at a level of from about 20% to about 80% by weight of the concentrated surfactant blend.

3. The process according to claim 2, wherein the resultant concentrated surfactant blend comprises the anionic surfactant at a level of from about 20% to about 30% by weight of the concentrated surfactant blend.

4. The process according to claim 2, wherein the resultant concentrated surfactant blend comprises the anionic surfactant at a level of from about 65% to about 70% by weight of the concentrated surfactant blend.

5. The process according to claim 1, wherein, in the blending step, the at least two different alkoxylated alcohols are blended together, to provide the alkyl alkoxylated alcohol stream, wherein the at least two different alkoxylated alcohols have a mol average degree of alkoxylation which differs by no more than about 0.25.

6. The process according to claim 5, wherein, in the blending step, the at least two different alkoxylated alcohols are blended together, to provide the alkyl alkoxylated alcohol stream, wherein the at least two different alkoxylated alcohols have a mol average degree of alkoxylation which differs by no more than about 0.15.

7. The process according to claim 1, wherein the anionic surfactant in the concentrated surfactant blend consists of the blend of alkyl alkoxylated sulfate anionic surfactant, and optionally non-alkoxylated alkyl sulfate anionic surfactant.

8. The process according to claim 1, wherein in the sulfation step, the sulfation is completed to a degree of sulfation of at least about 95%.

9. The process according to claim 1, wherein the alkyl alkoxylated alcohol in the alkyl alkoxylated alcohol stream has alkyl chains having a mol average alkyl chain length of from 8 to 18 carbon atoms.

10. The process according to claim 9, wherein the alkyl alkoxylated alcohol in the alkyl alkoxylated alcohol stream has alkyl chains having a mol average alkyl chain length of from 10 to 12 carbon atoms.

11. The process according to claim 1, wherein the resultant blend of alkyl alkoxylated sulfate anionic surfactant has an average degree of alkoxylation of from about 0.1 to about 2.0.

12. The process according to claim 1, wherein the alkoxylation of the alkyl alkoxylated alcohol in the alkyl alkoxylated alcohol stream is selected from ethoxylation, propoxylation, and a mixture thereof.

13. The process according to claim 1, wherein the alkyl alkoxylated alcohol in the alkyl alkoxylated alcohol stream has a weight average degree of branching of from about 15% to about 50%.

14. The process according to claim 11, wherein in the alkyl alkoxylated alcohol in the alkyl alkoxylated alcohol stream, the alkyl alcohol used to make the alkyl alkoxylated alcohol comprises C2-branched alkyl alcohol and non-C2-branched alkyl alcohol, wherein:
a. the weight ratio of non-C2-branched alkyl alcohol to C2-branched alkyl alcohol is greater than about 0.5; and
b. the non-C2 branched alkyl alcohol comprises less than about 30% by weight of the non-C2 branched alkyl alcohol of C1-branched alkyl alcohol.

15. The process according to claim 13, wherein in the alkyl alkoxylated alcohol in the alkyl alkoxylated alcohol stream, the alkyl alcohol used to make the alkyl alkoxylated alcohol comprises C2-branched alkyl alcohol and non-C2-branched alkyl alcohol, wherein:
a. the weight ratio of non-C2-branched alkyl alcohol to C2-branched alkyl alcohol is from about 1.0:1 to about 5:1; and
b. the non-C2 branched alkyl alcohol comprises less than about 20% by weight of the non-C2 branched alkyl alcohol of C1-branched alkyl alcohol.

16. The process according to claim 1, wherein the sulfation step is carried out in a liquid-gas interface reactor.

17. The process according to claim 16, wherein the sulfation step is carried out in a falling film reactor.

18. The process according to claim 1, wherein during or after the neutralisation step, the neutralising agent is added at a level to provide the resultant concentrated surfactant blend with a pH of from about 7.1 to about 12 measured as an about 10% by weight solution of the concentrated surfactant blend in demineralized water, at about 20° C.

19. The process according to claim 1, wherein the resultant concentrated surfactant blend has a 1,4-dioxane level of less than about 40 ppm expressed on an about 100% anionic surfactant active basis measured immediately after the neutralizing step.

20. The process according to claim 16, wherein the resultant concentrated surfactant blend undergoes a subsequent 1,4-dioxane removal step, wherein the 1,4-dioxane level is further reduced to less than about 10 ppm expressed on an about 100% anionic surfactant active basis, wherein the 1,4-dioxane removal step comprises 1,4-dioxane removal by steam stripping.

21. The process according to claim 1, wherein a buffering surfactant is added before or during the neutralising step, wherein the buffering surfactant is added at a level to provide the resulting concentrated surfactant blend with a reserve alkalinity of greater than about 0.02 when measured as an about 10% by weight solution of the concentrated surfactant blend in demineralized water at about 20° C., wherein the buffering surfactant is selected from the group consisting of: amine oxide surfactant, betaine surfactant, and mixtures thereof.
